(19) United States
(12) Patent Application Publication
(10) Pub. No.: US 2006/0224775 A1
(43) Pub. Date: Oct. 5, 2006

(54) Contents synchronization system in network enviroment and a method therefor

(75) Inventors: Nam-Yul Lee, Daejeon (KR); Kee-Joo Yoon, Seoul (KR)

Correspondence Address: DILWORTH & BARRESE, LLP, 333 EARLE OVINGTON BLVD., UNIONDALE, NY, 11553, US

(73) Assignee: NITGEN TECHNOLOGIES INC., Seoul (KR)

(21) Appl. No.: 10/563,984

(22) PCT Filed: Sep. 23, 2003
(86) PCT No.: PCT/KR03/01941

§ 371 Date: Jan. 9, 2006

(30) Foreign Application Priority Data
Aug. 1, 2003 (KR) 10-2003-0053545

(51) Int. Cl. G06F 15/16

(52) U.S. Cl. 709/248

(57) ABSTRACT

A contents synchronization method comprises steps for: setting the synchronization policy; monitoring files and directories of a specific server in real time; checking whether there is content modification; performing said monitoring step again if there are no modification, but if there is modification, notifying to the CD Master server in real time that there is modification; confirming whether there is failure among the CD Master server, the CMS server, the CAS servers; selecting a contents routing path if there is modification; selecting a contents routing path if there is no modification; instructing a synchronization command to transmit said modified contents to target servers; transmitting the contents to target servers; notifying the transmission results; confirming whether there is a next contents routing path; performing said step for confirming again whether there is failure if there is a next contents routing path but completing the contents synchronization if there is no path.

### BACKGROUND OF THE INVENTION

1. Field of the Invention

This invention relates to a CD-Master solution. Especially, this invention relates to a contents synchronization system in network environment including LAN and WAN and a method therefore.

2. Description of the Related Arts

Nowadays websites are appearing based on rapid growth of Internet, which hundreds of thousands to several millions of netizens are visiting a day. Such growth of Internet had the number of Internet users and traffic increase and induced service providers to upgrade server specification and to speed up network speed. However the server specification upgrade and network speed-up have a fault that the quality improvement cannot be expected in proportion to service provider's investment cost. A technology to overcome the fault is to purchase several web servers with similar performance and to establish a clustering system by using server load balancers.

Another solution is necessary so that several web servers clustered by load balancers may provide the service upon the purpose. It is a contents synchronization or contents clustering solution that keeps and manages the contents of all the web servers to be identical. Actually the contents synchronization can be processed only by using the tools provided in the corresponding operating system or by using the commands like tar, cp, cpio, cop, rcp, ftp, rsync without applying specific software.

However according to the increase of the quantity of contents and the number of servers, the method based on manual operation drops the business productivity and in case the synchronization among servers is not updated in real time, then service users may connect to unexpected other contents, although he connects to any server and identical service and contents should be provided for him.

As mentioned above, the establishment of server clustering system and real time contents synchronization among several contents servers according to the increase of the Internet users and traffic became necessary.

Also the former concept of a contents routing method among methods distributing contents from a centralized original contents server to several contents servers induced system load and severe network traffic of an original server by transmitting contents from an original server to several contents servers.

Other part not to be overlooked from a market trend is backup solution. The importance of backup in order to safely preserve the information of backup and service server about each person's job in enterprises is increasing day by day.

As for backup concept about the importance of information stored in each PC according to each person's job characteristics and important information of servers of a company, a countermeasure of information preserve as well as information recovery in case of accident should be able to be considered through establishment of backup system. However so far no technology to solve such a problem has been disclosed.

### SUMMARY OF THE INVENTION

In the present invention, it is an object to provide a contents synchronization system in network environment including LAN and WAN and a method therefore.

In the present invention, it is another object to provide a technology to realize intelligent data transmission, real time data monitoring, data filtering function's realization, selection of several synchronization objects per data, plural contents generator function, several data transmission methods, compressed data transmission, setting of various data transmission routes, transmission path bypass in network fault and grouping concept among CAS servers in contents synchronization.

The other object, features and advantages of the present invention will become more apparent by reading the detailed description of the following invention and making reference to the accompanied drawings.

A preferable embodiment of the present invention is that in network environment including LAN and WAN a Content Distribution Master (CD Master) that is a contents synchronization system transmitting the modified contents of source data servers to target servers, said CD Master comprising a Content Distribution Master server (CD Master server), a Content Monitoring System server (CMS server), a Content Agent System server (CAS server), a Server Monitoring Agent server (SM Agent server), a Content Distribution Master Admin Tool (CD Master Admin Tool) and an authentic server, wherein

said CD Master server manages data distribution and data transmission and controls the service circumstances of said CMS server, CAS server, SM Agent server and monitors the data transmission status and the status of said CMS server, CAS server, SM Agent server, CD Master Admin Tool, authentic server;

said CMS server monitors in real time at the operating system level whether the data of folders designated by a network manager are created, modified or deleted, and notifies the modified contents to said CD Master server;

said CAS server transmits data to other CAS servers or receives data from other CAS servers according to the instruction of said CD Master server;

said SM Agent server collects server status information about CPU, Memory, Session number of the installed CD Master server, CMS server, CAS server, CD Master Admin Tool, authentic server every constant time interval periodically and notifies the collected information to said CD Master server;

said CD Master Admin Tool of GUI (Graphic User Interface) environment being independent from operating system platform based on the development in Java environment and is a management tool to support that said CD Master system manager sets CD Master service environment easily and provides intuitive interface and sets and confirms the service environments including service server management, environment setting between said CMS server and CAS server, manager's account management, server status monitoring, scheduling, synchronization, server monitor agent setting, job log confirmation, operating environment setting through CD Master server; and

said authentic server is a license system of said contents synchronization system and issues and manages CD Master License Keys and classifies servers as tree-structured three levels of Region, Group, Server for effective contents synchronization among servers grouped based on network topology being served actually, wherein Region is the highest level, Group is a medium level, and Server is a lowest level, and manages Region, Group, CAS server, CMS server and the restriction of the usable days for operating said synchronization system.

A preferable embodiment of the present invention is that in network environment including LAN and WAN a contents synchronization method using a content synchronization system transmitting the modified contents of source servers to target servers, said system having a Content Distribution Master server (CD Master server), a Content Monitoring System server (CMS server), several Content Agent System servers (CAS servers), a Server Monitoring Agent server (SM Agent server), a Content Distribution Master Admin Tool (CD Master Admin Tool) and an authentic server, said method comprising:

a step for setting the synchronization policy by the CD Master Admin Tool;

a step for monitoring files and directories of a specific server in real time according to the set policy by the CMS server;

a step for checking by the CMS server whether there are creation, modification, deletion or move of contents as a result of the monitoring;

a step for performing said monitoring step again if there are no creation, modification, deletion or move of contents as a result of said check, but if there are creation, modification, deletion or move of contents, then notifying of the CMS server to the CD Master server in real time that there are creation, modification, deletion or move of contents;

a step for confirming by the CD Master server whether there is failure among the CD Master server, the CMS server, the CAS servers according to the contents routing path;

a step for selecting a predefined contents routing path if there are creation, modification, deletion or move of contents as a result of said confirmation;

a step for selecting a contents routing path by selecting a bypass if there are no creation, modification, deletion or move of contents as a result of said confirmation;

a step for instructing by the CD Master server a synchronization command to each CAS server to transmit said created, modified, deleted or moved contents to target servers;

a step for transmitting the corresponding contents to target servers according to designated path or bypass by the CAS server;

a step for notifying the transmission results to the CD Master server by the CAS server after said transmittance;

a step for confirming by the CD Master server whether there is a next contents routing path; and

a step for performing said step for confirming by the CD Master server whether there is failure among the CD Master server, the CMS server, the CAS servers again if there is next contents routing path but completing the contents synchronization if there is no next contents routing path as a result of said confirmation.

### BRIEF DESCRIPTION OF THE DRAWINGS

FIG. 1 illustrates a brief system block diagram to perform contents synchronization;

FIG. 2 illustrates a flow chart of a contents synchronization method by contents synchronization solution according to the present invention;

FIG. 3 illustrates a block diagram of a CD Master according to the present invention;

FIG. 4 illustrates a block diagram of a CAS server according to the present invention;

FIG. 5 illustrates an operation principle of a CAS server according to the present invention;

FIG. 6 illustrates a flow chart of a data transmission algorithm of a CAS server according to the present invention;

FIG. 7 illustrates a block diagram of a CMS server according to the present invention;

FIG. 8 illustrates a flow chart of operation of an SM Agent server according to the present invention;

FIG. 9 illustrates a function block diagram of CD Master Admin Tool according to the present invention;

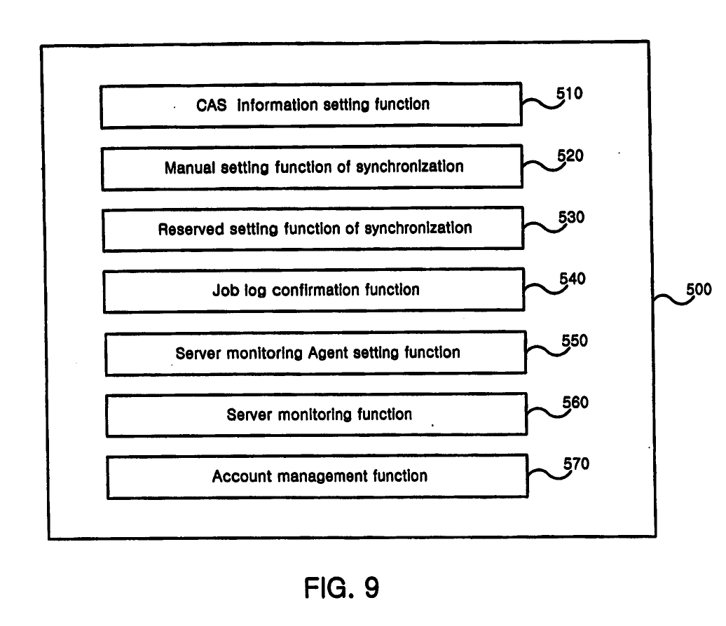

FIG. 10 illustrates a CMS server environment-setting screen of a CD master Admin Tool according to the present invention;

FIG. 11 illustrates a CAS server environment-setting screen of a CD master Admin Tool according to the present invention;

FIG. 12 illustrates a general LAN's constitution;

FIG. 13 illustrates an example of server grouping tree according to the present invention;

FIG. 14 illustrates a server group clustered through a load balancer according to the present invention;

FIG. 15 illustrates a flow chart of a CD Master License Key generating procedure according to the present invention;

FIG. 16 illustrates a block diagram of a prior contents synchronization method;

FIG. 17 illustrates an example of contents synchronization of CD Master according to the present invention;

FIG. 18 illustrates concept for contents synchronization according to the present invention;

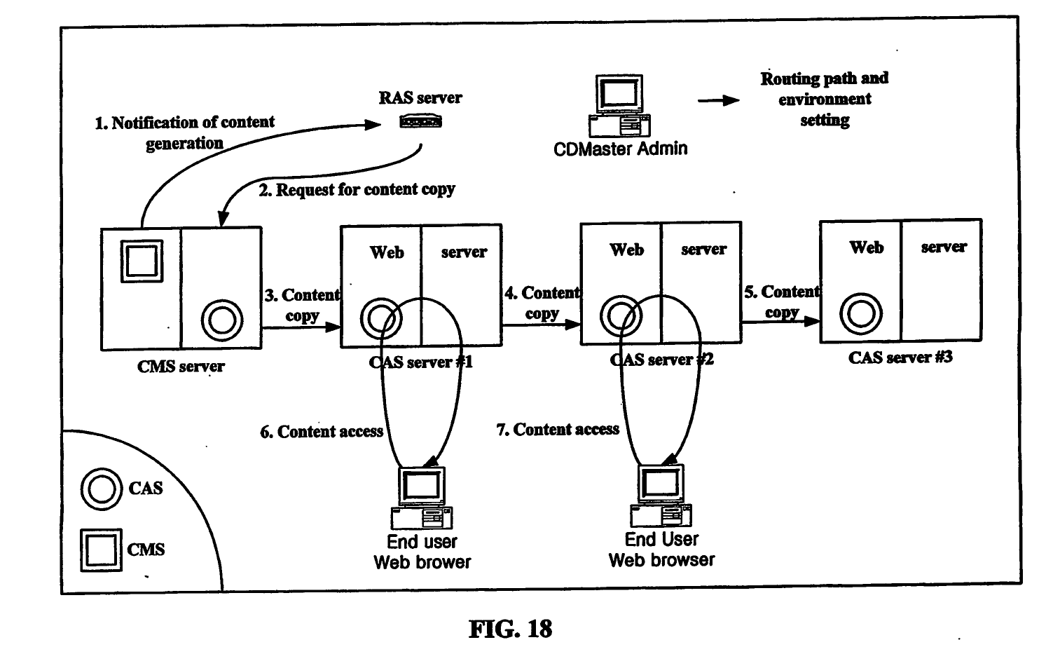

FIG. 19 illustrates the comparison of the existing synchronization method and a synchronization method according to the present invention;

FIG. 20 illustrates an example of contents transmission per contents and servers;

FIG. 21 illustrates function of multiple contents generator according to the present invention; and

FIG. 22 illustrates an example of intelligent data transmission using checksum according to the present invention.

### SIMPLE EXPLANATION ABOUT IMPORTANT PARTS OF DRAWINGS

CAS: Content Agent System

CD: Content Distribution

CMS: Content Monitoring System

LAN: Local Area Network

SM: Server Monitoring

WAN: Wide Area Network

100: CD Master Server

110: Communication Control Unit

120: Contents Transmission Management Unit

130: Server Fail Over Management Unit

140: Real time server status monitoring management unit

150: Contents transmission job logging and statistical information management unit

200: CMS Server

205: Device driver of OS kernel level

210: CMS Agent

220: Environment setting file for contents synchronization

230: File detect buffer

300: CAS server

310: CAS Agent

320: Sync Client

330: Sync server

340: Routing table for contents synchronization

400: SM Agent server

500: CD Master Admin Tool

510: CAS information setting function

520: Manual synchronization setting function

530: Reserved synchronization setting function

540: Job log confirmation function

550: Server monitoring Agent setting function

560: Server monitoring function

570: Account management function

600: Authentication server

1000: CD Master

### DESCRIPTION OF THE PREFFERED EMBODIMENTS

A preferred embodiment of contents synchronization system in network environment according to the present invention is CD Master (1000) and synchronizes original contents to the several contents servers and may transmit contents by designating source target not in 1:N method among servers having CAS server (300), CMS server (200) but in N:M method, wherein 1:N manner is an existing centralized contents synchronization method. And this embodiment provides a contents synchronization method and a management method that can perform data synchronization and data back-up in all the fields as an application, and perform data back up easily and automatically in real time for PC as well as each company's important server. The N:M method means that every server can become source and target at the same time and therefore several sources can transmit contents to any several targets.

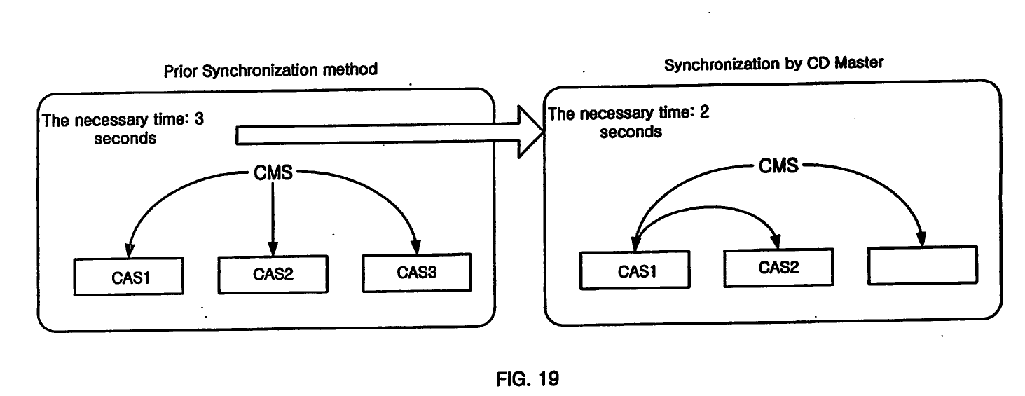

FIG. 19 illustrates the comparison of the existing synchronization method and a synchronization method according to the present invention. In the figure the left denotes an existing synchronization method and the right a synchronization method according to the present invention. If we assume that a copy time is 1 second, then in this example 3 seconds were necessary in the past but two seconds is necessary according to the invention. It means that more quick copy can be performed by this invention. That is, according to the invention the job can be distributed according to the quantity of each service facility.

### A Preferred Embodiment

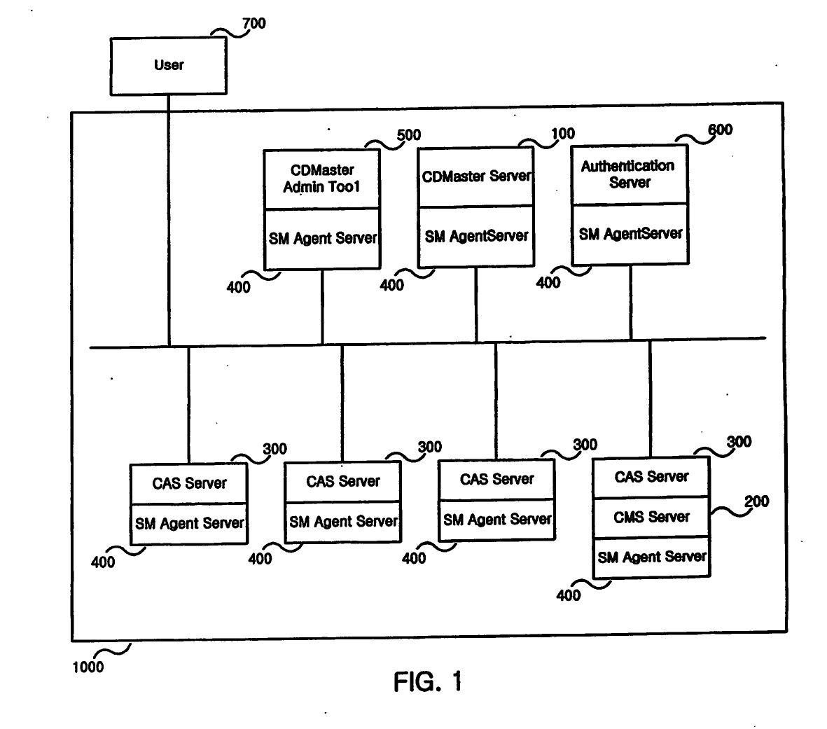

Hereinafter we explain the constitution of an embodiment of the invention referring to the attached drawings. FIG. 1 illustrates a system block diagram of an embodiment about contents synchronization according to the present invention.

In the embodiment, CD Master (1000) denoted by a dotted line comprises CD Master server (100), a CMS server (200), several CAS servers (300), several SM Agent server (400), a CD Master Admin Tool (500) and an authentication server (600) and these components operate organically each other and perform contents synchronization policy establishment, synchronization, job management and system information monitoring.

1. CD Master Server

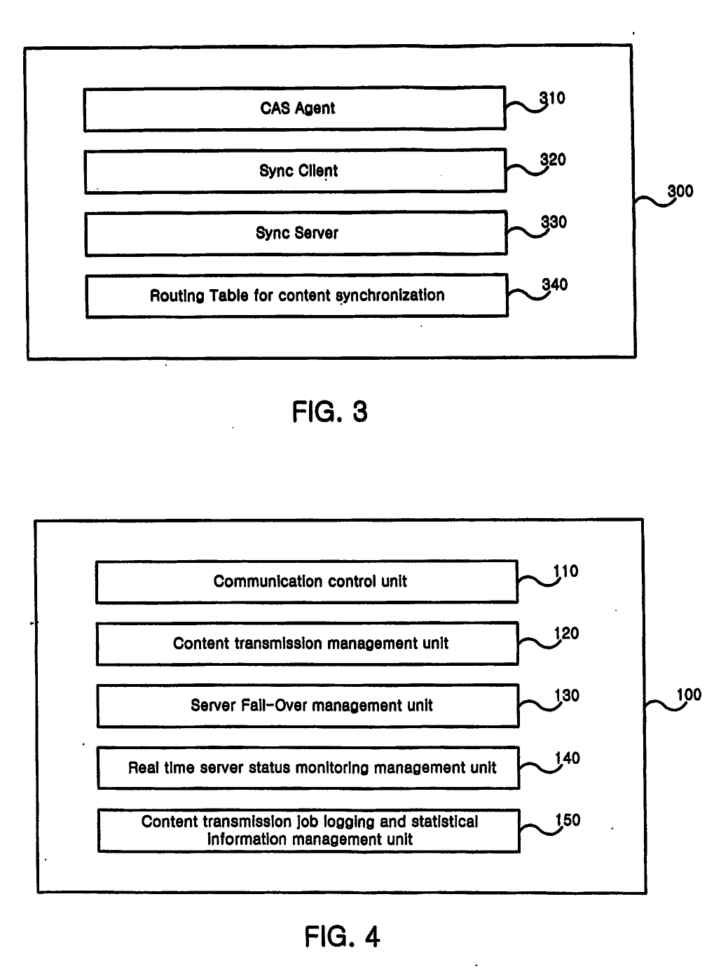

The CD Master server (100) shown in FIG. 3 is a system to manage content routing table and manages the real time distribution of modified contents, manual distribution, reserved distribution in the center, and comprises communication control unit (110), contents transmission management unit (120), server fail over management unit (130), real time server status monitoring management unit (140) and contents transmission job logging and statistical information management unit (150).

CMS server (200) notifies to CD Master server (100) data modification and the server (100) manages data distribution and transmission and controls the service circumstances of CMS server (200), CAS server (300), SM Agent server (400) and monitors the data transmission status and the status of each component (200)(300)(400)(500)(600). Generally SM Agent server (400) is installed in the server (100).

The communication control unit (110) controls service environment of CAS server (300), CMS server (200), components of CD Master (1000), and monitors the status of the CD Master server (100) in the path of content transmission path and specifies the bypass in case of fault and controls the communication flow through the communication protocol with CD Master server (100), a CMS server (200), several CAS servers (300), several SM Agent server (400), a CD Master Admin Tool (500) and an authentication server (600).

The contents transmission management unit (120) controls the distribution and management of information related to the real time distribution, manual distribution, reserved distribution of contents.

The server fail over management unit (130) controls the specification of the bypass for contents synchronization among each server (100)(200)(300) in case of fault of server (100)(200)(300) in routing path.

The real time server status monitoring management unit (140) monitors the status of CPU, memory, socket etc. of service facilities like CMS server (200), CAS server (300) and outputs the status of the servers (200)(300) in form of graph or table, and if the status of CPU, memory, socket of the servers (200)(300) is abnormal or the manager reports the result that is above the predetermined threshold value, then it is informed to the manager at once.

In other words, the real time server status monitoring management unit (140) stores and controls the data about CPU, memory, session, which are collected information from SM Agent server (400) actually.

The contents transmission job logging and statistical information management unit (150) performs the real time synchronization, reserved synchronization, manual synchronization about the modified contents of the CMS server (200) and records and controls the logging and statistical information about the synchronization results.

2. CMS Server

When the data in a folder to be monitored in real time by a network manager is created, modified or deleted, the CMS server (200) notifies the modified contents to the CD Master server (100) by using the real time monitoring function about the corresponding contents in kernel level of operating system to reduce the CPU burden. That is, the CMS server (200) receives the environmental files about patterns of files to monitor and information about files and directories to monitor the creation, deletion, modification, move of files from the CD Master server (100) and if there is file modification in the corresponding registered environment, notifies the modification of files and directories to the CD Master (1000). Generally it is possible that the SMA Agent server (400) is installed in the CMS server (200) and as in this embodiment the CAS server (300) and SM Agent server (400) are installed at the same time.

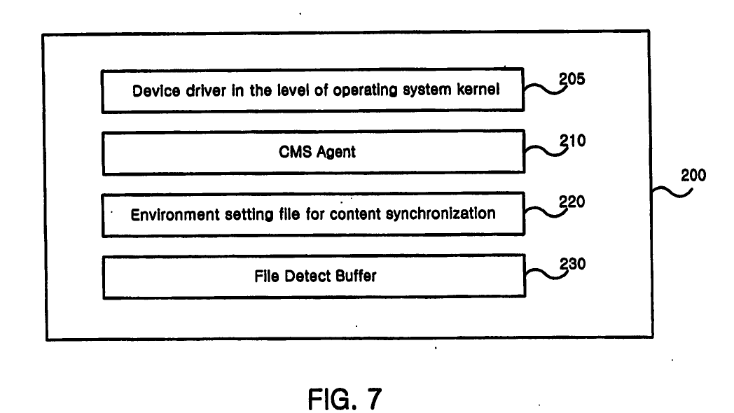

FIG. 7 shows the constitution of the CMS server (200). The CMS server (200) comprises CMS Agent (210), which monitors the contents modification in real time in device driver (205) of kernel level of operating system and notifies the information of creation, deletion, change, move to the CD Master server (100); environment setting file (220), which defines original directory, file, synchronized pattern etc to perform contents synchronization; File Detect Buffer (230), which monitors the above referred contents modification in real time and stores the information of creation, deletion, change and move.

The real time data monitoring function of the CMS server (200) recognizes the creation, modification, deletion status of data. The data monitor process of the CMS server (200) operates at the kernel level of the server operating system and so the CPU's burden is minimized and operates correctly.

The environment setting file (220) for contents synchronization includes file-monitoring directory, file-monitoring policy, contents routing path, control command setting. For example, file monitoring directory for synchronization setting as in Windows D:\CMS Reserve, in UNIX series/home/CMS Reserve is set.

The file monitoring policy defines the monitoring pattern about files the file monitoring directory and can set whether the file is to be included in file monitoring pattern or excluded. For example, if in a monitoring rule to be excluded from the monitoring objects *.txt is set, although the *.txt is created in the corresponding monitoring directory, the synchronization of all files except the file is performed.

The contents routing path calculates the load distribution of a system effectively through the set CAS server (300) path and synchronizes among files automatically or manually.

The control command set has set information about whether the commands CREATE, UPDATE, DELETE, MOVE, ERASE about the creation, modification, deletion of files in monitoring directory are contained in synchronization or not.

3. CAS Server

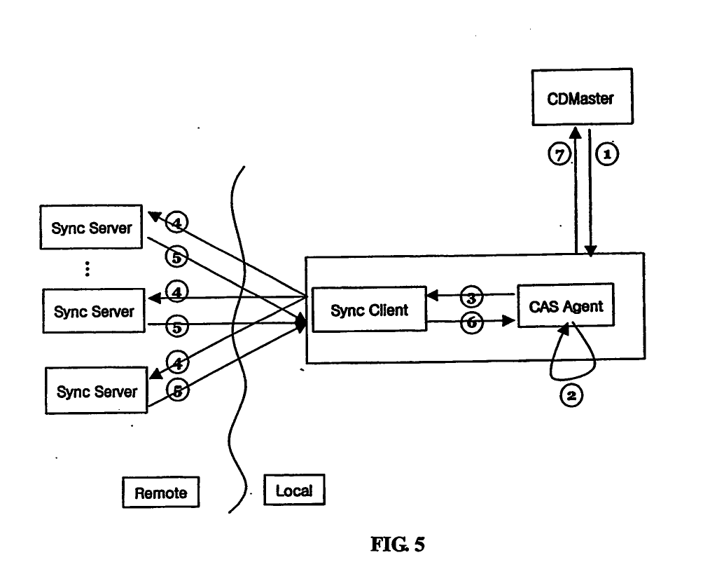

The CAS server (300) is a tool providing contents service (for example web server) and transmits data in a folder designated by a manager according to the instruction of the CD Master server (100) or receives data in a folder designated by the manager through other CAS server (300). Generally SM Agent server (400) is installed in the server (300). The CAS server (300) of the FIG. 4 comprises a Sync server (330) that copies, creates, updates, renames, deletes/erases, moves the files and folders of monitor directory monitored by the CMS server (200) according to the instruction of the CD Master server (100) and transmits data to other CAS server (300) or receives data from other CAS server (300) and internally stores remote files to the local through the communication according to the job request of the remote sync client (320) as independent process from the CAS server (300); sync client (320), a part communicating with the remote sync server (330) actually and installed in the CAS server (300) performing the create, update, rename, delete, erase, move functions according to the instructions of the CAS server (300); routing table (340) for the contents synchronization; and CAS agent (310) performing the commands received from the CD Master (1000).

4. SM Agent Server

The SM Agent server (400) collects server status information about CPU, Memory, Session number of the installed servers (100)(200)(300)(500)(600) and updates it and if there is physical error in servers or the information about CPU, Memory, Session is above a threshold value, then the server (400) notifies to a manager by using E-mail, SMS, Alarm function the servers are normal or not, and notifies the server's status information to the CD Master server (100).

5. CD Master Admin Tool

The CD Master Admin Tool (600) of GUI (Graphic User Interface) environment is a management tool to support so that a CD Master system manager set CD Master service environment easily and provides intuitive interface, CAS server (CMS server, CAS server environment set) information set function (510), manual synchronization set function (520), reserved synchronization set function (530), job log check function (540), SM Agent server (400) set function (550), server monitoring function (560) and account management function (570). It is a kind of console.

CAS server (CMS server, CAS server environment set) information set function (510) sets synchronization environment of CMS server (200) and CAS server (300) as the CMS server (200) sets files and folders to monitor and sets data synchronization path, sets monitoring pattern, sets the path to designate data received from the CAS server (300) installed in other CMS server (200).

Also the function (510) controls CAS server Config set, CMS server Config set by the environment set function. The manual synchronization set function (520) and the reserved synchronization set function (530) controls the manual and reserved synchronization of a specific file/directory of present time that is a contrary concept of the real time synchronization occurring under the control of a manager.

The job log check function (540) confirms all the job logs about all the synchronization job, manual, reserved job etc. that occur under the control of the CD Master server (100).

The SM Agent server (400) set function (550) controls so that a network manager adds an SM Agent server (400) to the CMS server (200) and CAS server (300) to be the object of service of the CD Master (1000) and modifies and deletes the environment of the previously registered service server.

Through the server monitoring function (560) the SM Agent server (400) provides the status information about the present CPU, Memory, Session of the being drived servers in the form of various graphs and table.

The account management function (570) makes the manager account and manager information create, modify, delete, wherein the manager account and manager information makes it possible to access to the CD Master Admin Tool (500).

The CD Master Admin Tool (500) is an application developed at the JAVA environment and provides the GUI environment that makes the Tool (500) operate not constrained in the OS (Operating System) platform and from its result it has a merit to manage network easily and simply and solves a problem according to the constriction of the program install.

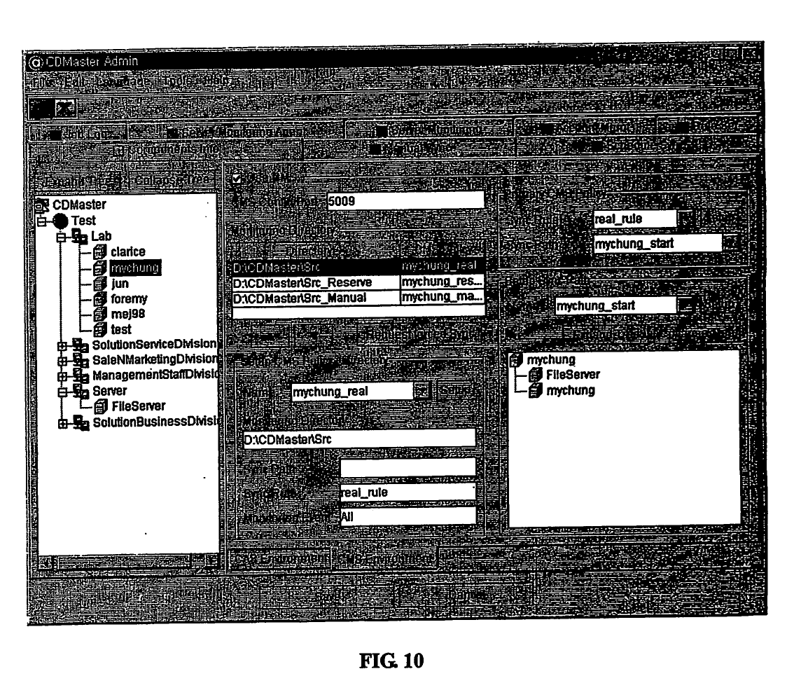

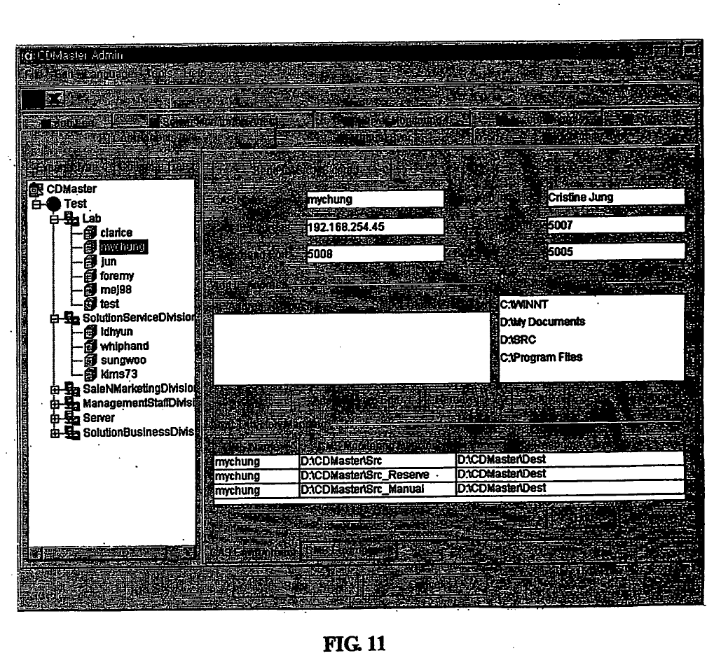

On the other hand, the FIG. 10 illustrates a CMS server environment-setting screen of a CD master Admin Tool according to the present invention, and the FIG. 11 illustrates a CAS server environment-setting screen of a CD master Admin Tool according to the present invention. On the upper sides of the FIG. 10 and the FIG. 11, there are shown menus about CAS server (300) information, manual synchronization, reserved synchronization, job log, server monitor Agent, server monitoring, account management.

The tree structures of the figures show network constitutions consisting of components of Area or Region, Group and Server.

The panel of the right side of the figures is for setting items for environmental setting of the CMS server (200). The contents of the environmental setting of the CMS server (200) can set the directory information to monitor, the file filtering policy in a directory to monitor, the routing for synchronization etc.

The environmental setting contents of the CAS server (200) of the FIG. 11 can set the information related to the communication environment, the original directory, the mapping directory etc of the CAS server (300).

6. Authentic Server

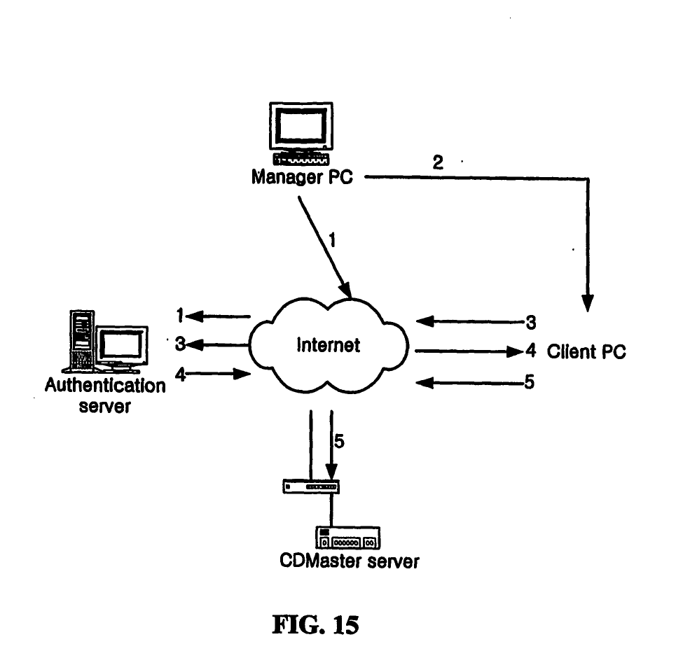

The authentic server (600) is a system for issuing and managing a CD Master License Key and manages Region, Group, CAS server (300), CMS server (200) and the restriction of the usable days etc for operating the CD Master (1000). Normally the SM Agent server (400) is installed in the server (600). The procedure for issuing the license key is shown in the FIG. 15 and the explanation of it is described below.

The authentic server (600) distinguishes the levels into the tree structure levels, i.e. the uppermost level as Region, the medium level as Group, the lowest level as Server for effective contents synchronization among grouped servers based on network topology being served actually.

7. Contents Synchronization Method

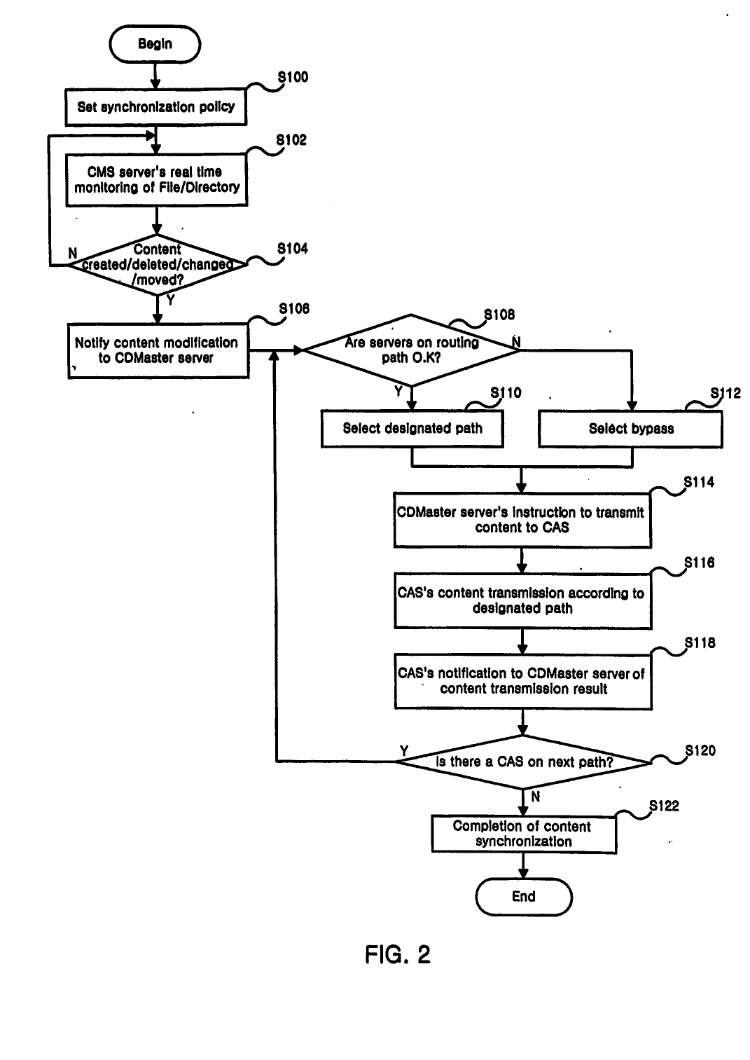

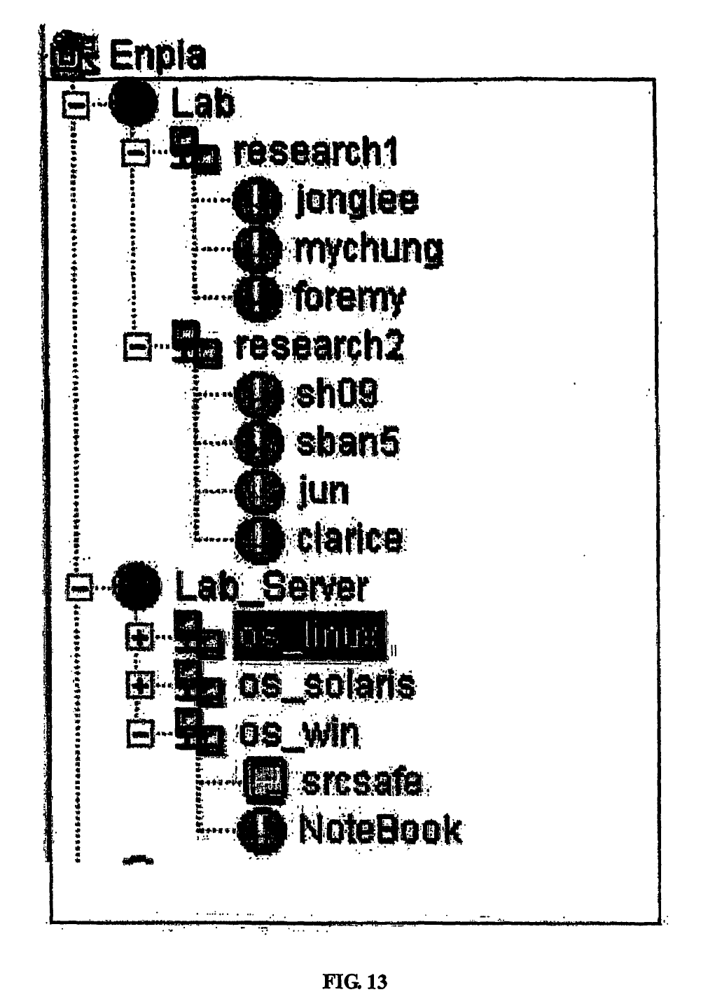

FIG. 2 illustrates a flow chart of a contents synchronization method by contents synchronization solution according to the present invention and explains a contents synchronization method in case that the contents among the CD Master (1000), CMS server (200) and CAS server (300) is changed. And FIG. 13 illustrates an example of server grouping tree according to the present invention.

The contents synchronization procedure is as follow: If the CMS server (200) notifies the information about new contents to the CD Master server (100), then the CD Master server (100) searches the contents routing information table and asks contents copy to each CMS server (200) and CAS server (300), and each CMS server (200) and CAS server (300) notifies the job results to the CD Master server (100) and informs that the copy was completed. The contents move is progressed in the order of path like CAS server 1 (300), CAS server 2 (300), CAS server 3 (300), . . . , CAS server N (300).

A more detailed contents synchronization i.e. contents transmission method of the CD Master (1000) comprises a step (s100) for setting the synchronization policy in the CD Master Admin Tool (500), a step (s102) for monitoring files and directories of a specific server in real time according to the set policy by the CMS server (200), a step (s104) for checking by the CMS server (200) whether there are creation, modification, deletion or move of contents as a result of the monitoring, a step (s106) for performing the step (s102) again if there are no creation, modification, deletion or move of contents as a result of the check, but if there are creation, modification, deletion or move of contents, then notifying of the CMS server (200) to the CD Master server (100) in real time that there are creation, modification, deletion or move of contents, a step (s108) for confirming by the CD Master server (100) whether there is fault between each server (100)(200)(300) according to the contents routing path, a step (s110) for selecting a predefined contents routing path if there are no creation, modification, deletion or move of contents as a result of the confirmation, a step (s112) for selecting a contents routing path according to the bypass if the are creation, modification, deletion or move of contents, a step (s114) for instructing a synchronization command ‘Distribution Job’ so that the CD Master server (100) transmits contents to each CAS server (300), a step (s116) for transmitting contents according to the specified path or bypass by the CAS server (300), a step (s118) for notifying the transmitted results to the CD Master server (100) by the CAS server (300) after the contents transmission, a step (s120) for confirming by the CD Master server (100) whether there is a next contents routing path, a step (s122) for performing the step (s108) again if there is but completing the contents synchronization if there is no next contents routing path.

The CD Master (1000) consisting of the components (110)(120)(130)(140)(150) provides with the functions of data filtering, setting the various synchronization objects according to the data, various data transmission methods (for example, real time transmission, manual transmission, reserved transmission), setting the various data transmission paths, transmission via bypass i.e. data transmission fail-over in case of network fault.

The data filtering function helps that the CD Master (1000) can make a manager specify the kind of data to transmit to the next target server. That is, it is possible according to the function to only transmit a specific kind of data or exclude a specific kind of data files from the transmission. The data filtering function uses a regular expression method (for example, .mpg/*.*). Namely, the data filtering function is performed through the regular expression method. For example, all the regular expressions *abc, abc*, [1-5]abc, a??bc can be used, wherein ‘*abc’ means all patterns having character series ending with ‘abc’, ‘abc*’ means all patterns having character series beginning with ‘abc’, ‘[1-5]abc’ means all patterns having character series of 1abc˜5abc, ‘a??bc’ means all patterns consisting of 5 characters beginning with ‘a’ and ending with ‘bc’.

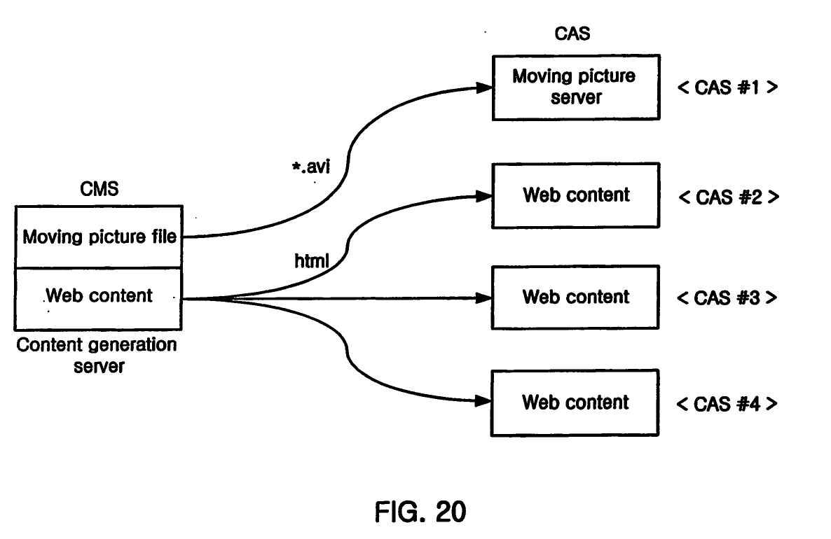

The setting function of various synchronization objects per data becomes apparent from the recent web site constructing methods. In the recent web site construction specific servers provide image only and other specific servers provide streaming services only etc. Like this it is apt to install exclusive server respectively according to the kind of data. If the data is created or changed in a specific server according to a manager's setting, the CD Master (1000) can transmits the data to designated servers. For example the image created or changed newly in a manager's PC (CMS server) creating total web data is transmitted to a designated image server (CAS server). At this time it is possible to monitor the real time modification of contents if CMS servers (200) are installed basically in every directories to monitor original data. FIG. 20 illustrates an example of contents transmission by contents and servers based on the above concepts.

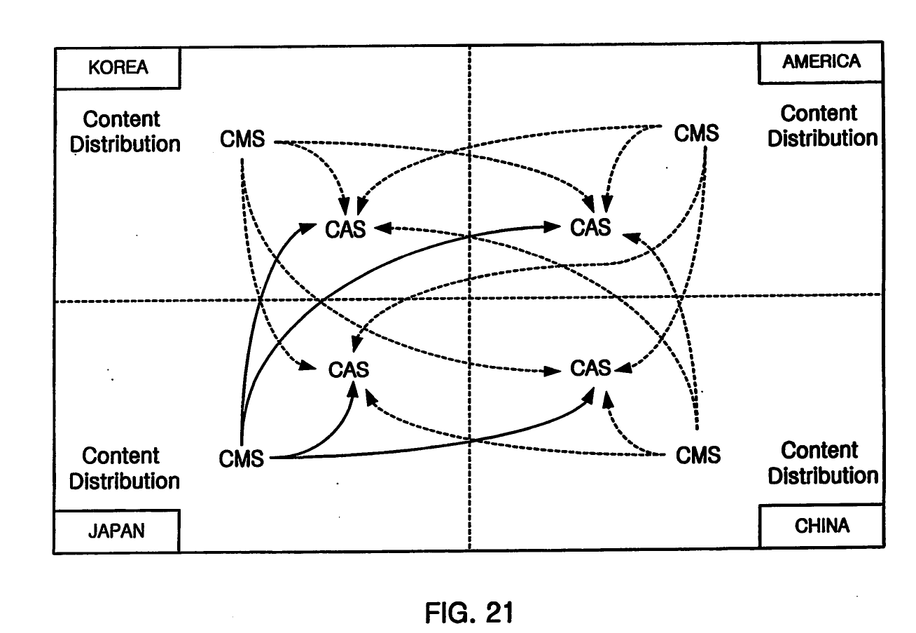

As shown in FIG. 21, the multi contents generating function makes it possible that the CD Master (1000) designates the synchronization timing of data diversely. This function provides a function to perform synchronization and backup of data by transmitting data in above two source servers to all the target servers. According to this function every changed data of a specific data center is transmitted to target servers of another network center or another region, wherein the existing data transmission solution adopts 1:N type data transmission service but the present invention adopts true N:M type data transmission service.

The diverse data transmission function makes that the data synchronization timing of target servers is set as one of the following three types in case data of source server is changed. The first one is a real time transmission to transmit data at once to all the target servers when it is changed, and the second one is a manual transmission for a manager to instruct transmission of data manually, and the third one is a reserved transmission to transmit data at a designated specific time or every regular time interval.

Normally the reserved transmission is used primarily because data transmission for synchronization imposes a burden to network and server CPU and this transmission is performed when the least users connect for service.

While the existing data transmission method for contents synchronization transmits data from a source to multiple targets respectively, the diverse data transmission path setting function makes it possible that the CD Master (1000) has a manager set the data transmission path flexibly according to the network structure and server status. It is possible because the CD Master (1000) uses a grid network method. In a grid network structure it is possible to perform the synchronization and backup of data of every region by an application because every computing resource can play a role as a source and a target simultaneously.

The grid network method makes it possible to complete the contents replication at a shortest time by allotting a role of each service server, and to reduce the burden of CPU and network of each service server up to the least, and to distribute the load according to the hardware specification of each service server.

When network or server is in fault status, the data transmission fail-over function makes it possible for a CD Master (1000) to transmit data via the bypass after monitoring the fault for cases, wherein a case is when unexpected network fault between two points occurs as data is not transmitted correctly according to network or server fault, and another case is when data is not transmitted because a server fault occurs or load increases above a threshold value of CPU, memory, socket of a server during the time a manager is transmitting data through the existing set data transmission path (contents routing path) by using a CD Master Admin Tool (500).

For the bypass provided above it is possible to confirm whether the region of the bypass is the same as a fault region of an existing composed network, or whether the group of the bypass is the same as a fault group of the network, or whether the region of the bypass is an international region of an existing composed network and to receive contents again from the nearest CAS server (300). At this time if data cannot be transmitted because of fatal problem of a server, the transmission of data is tried several times up to designated times. It is a method to reduce the load of networks and servers by successive retry. When fault occurs in network or server, the automatic data transmission fail-over function checks a server's status and reduces faults of contents synchronization.

When the CAS server (300) fails in transmission and the recovery of fault of a corresponding server is tried, the CD Master server (100) synchronizes contents for the corresponding server for which retransmission failed in spite of a preset server recovery procedure. The recovery procedure can be set selectively according to the situations whether contents synchronization will be performed at once after recovery of fault of server or at the reserved time designated by a manager or CAS server's synchronization will be performed when the CAS server failed in manual recovery.

8. Operation of a CAS Server

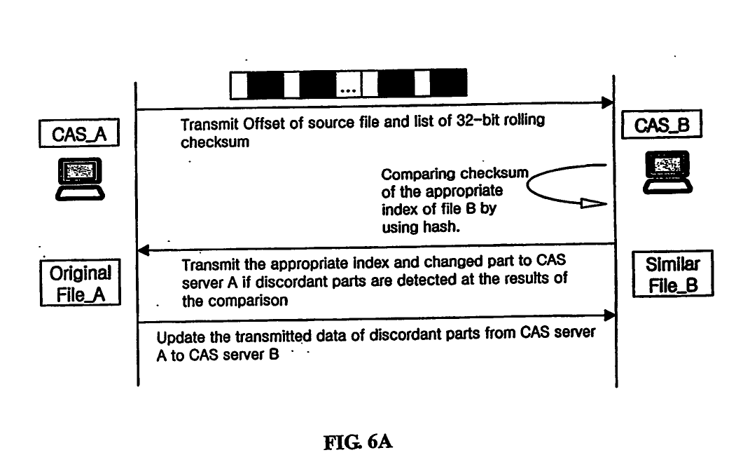

FIG. 5 illustrates an operation principle of a CAS server (300). A CAS server(300) operates through \textcircled{1} a step (s210) for receiving job for synchronization from CD master server (100), \textcircled{2} a step (s220) for confirming IP address of CAS server (300) that would execute synchronization by searching the routing table stored in CAS server (300), \textcircled{3} a step (s230) for calling Sync Client (320) locating in CAS server (called as CAS module too) (300), \textcircled{4} a step (s240) for executing create, update, rename, delete(or erase) and move for synchronization in the CAS server (300) by Sync Client (320) in the server, wherein this step is a step to process real jobs, \textcircled{5} a step (s250) for transmitting the results of job to Sync Server(330) locating at a long distance, \textcircled{6} a step (s260) for returning the results of job to CAS agent by local Sync Client (320), \textcircled{7} a step (s270) for performing the whole job and receiving the performed results of the whole job from each CAS server (300) and transmitting the results to a CD Master server (100).

In the file transmission between the CAS servers (300), the compressed data transmission function can minimize the load of network by means of supporting the compression and encryption by section of LAN or WAN in contents synchronization. The compression/encryption method of CD Master (1000) has an advantage that the method can be set in file transmitting policy.

The file transmitting policy appoints the file transmission by considering the characteristics of network structure like International Region, Same Region, Same Group, wherein the International Region doesn't to the Same Region or the Same Group. In the file transmitting policy a whole file is transmitted (dump copy) or the changed part of a file (different patch) is transmitted after comparing files, wherein it is preferable that the compression rate is set as multi-step like 0˜9 steps, and it can be defined by combination of AND condition (logical multiplication) whether encryption will be used or not. That is, the present invention differs from the existing synchronization solution in that can appoint multi-step compression rate, SSL encryption and whether it will be dump copy or different patch at the same time for execution of contents synchronization.

At the present invention, the manager can set compression rate properly by section by considering bandwidth of network of each transmitting sector. For example, when contents are transmitted among servers locating in the same LAN sector, for example, compression rate can be set low by considering high speed of the network, and in the WAN using a sector of Internet, the compression rate can be set high to reduce the quantity of transmitting data.

CD master (100) supports the packet encryption of transmitting data using SSL in order to protect important data and contents of enterprises or individual persons. And it can prevent the leakage of information caused by hacking when data is transmitted using encryption in the WAN sector. It can define SSL encryption sector selectively among the whole transmitting sectors of source server and target server. Because it cab be a useful method from data protection point of view as well as the increase of transmitting rate to set to reflect network condition of LAN/WAN sector as maximally as possible. It can reduce load of the server and network through performing file synchronization by a different patch method in case the contents are updated frequently.

9. A Synchronization Transmission Algorithm of a CAS Server

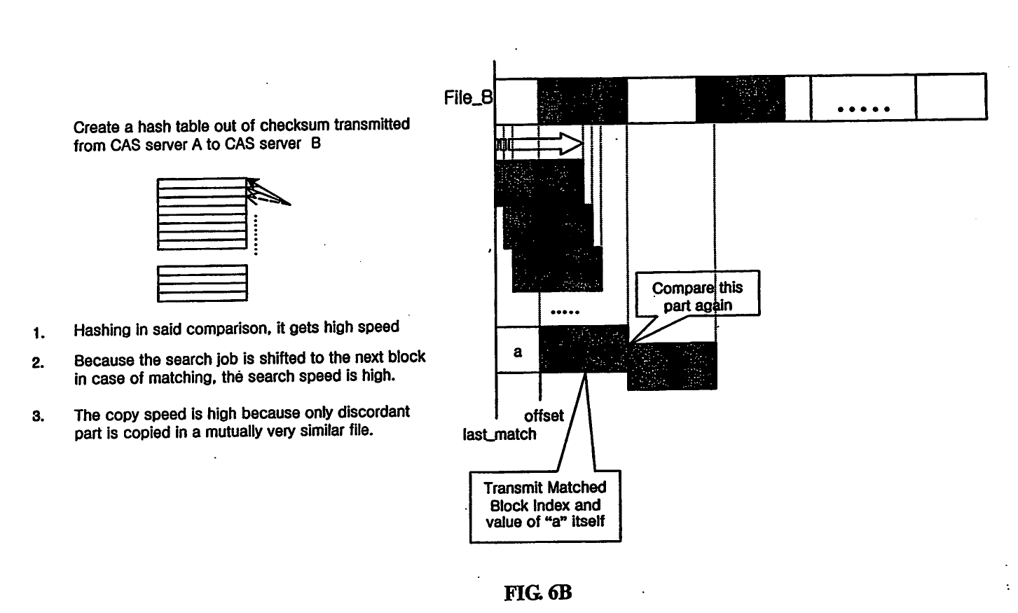

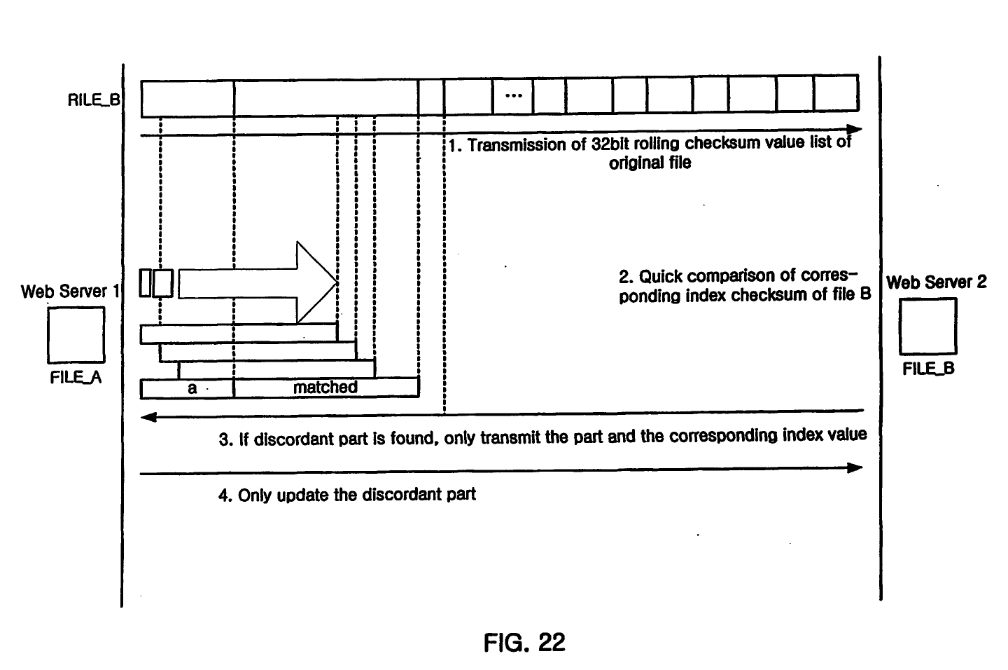

FIG. 6 illustrates a flow chart of a synchronization transmission algorithm of a CAS server (300). This algorithm comprises a step (s310) for transmitting Offset of source file and list of 32-bit rolling checksum from CAS server (300) A to CAS server (300) B, in case of existing similar file between CAS server (300) A and CAS server (300) B, a step (s320) for by CAS server (300) comparing checksum of the appropriate index of file by using hash speedily B, a step (s330) for transmitting the appropriate index and changed part to CAS server (300) A if discordant parts are detected at the results of the comparison, a step (s340) for updating the transmitted data of discordant parts from CAS server (300) A to CAS server (300) B (s340). FIG. 22 shows an example like this.

When there exist similar files between source CAS server (300) and target CAS server (300), it can reduce load of server and network by different patch method. And as shown in FIG. 6b, in comparing checksum in a CAS server (300), data transmission speed is improved by a hashing method. That is, it creates a hash table out of checksum that transmitted from CAS server (300) A to CAS server (300) B, and compares the hash table with the checksum of each index of file B in the figure. Because of hashing in said comparison, it gets high speed. And, because the search job is shifted to the next block in case of matching, the search speed is high. In addition to, the copy speed is high because only discordant part is copied in a mutually very similar file.

10. Operation of an SM Agent Server

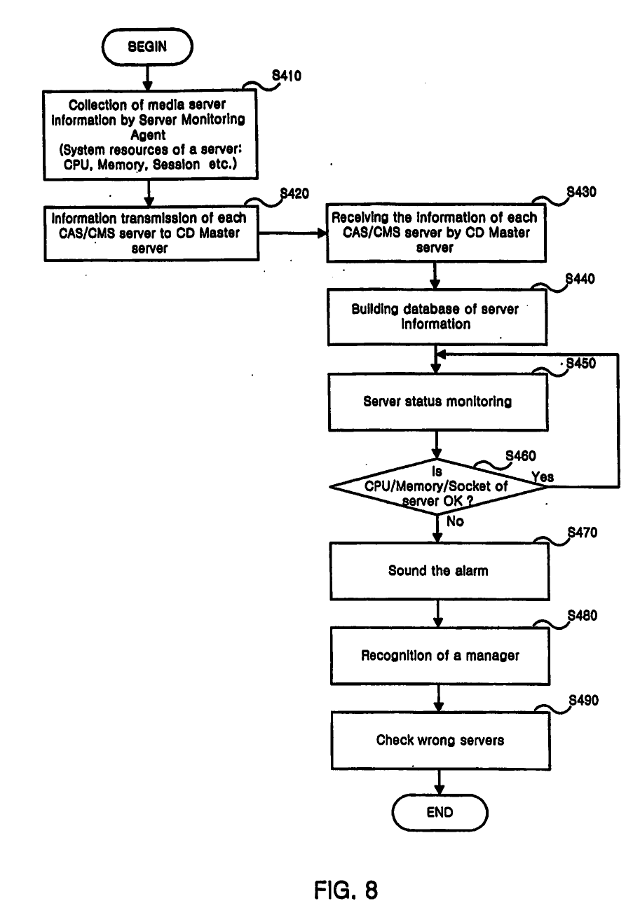

FIG. 8 illustrates a flow chart of operation of an SM Agent server (400). Operation of an SM Agent server (400) comprises a step (s410) for by SM Agent server (400) collecting information about CPU, Memory and Session, wherein these are system resources of media server that is a target server, a step (s420) for transmitting said collected information to CD Master server (100) by each CAS server (300) and CMS server (200), a step (s430) for receiving said collected information by CD Master server (100), a step (s440) for constructing database from said received data by CD master server (100), a step (s450) for monitoring the condition of target server from said collected information, a step (s460) for detecting whether there is abnormality about CPU, Memory and Socket of target server, a step (s470) for executing said real time monitoring step (s450) if said abnormality was not detected, or reporting abnormality of server to a manager through an alarm, SMS and E-Mail by CD Master server (100) if abnormality was detected, a step (s480) for recognizing said abnormality through CD Master Admin Tool (500) based on said report by the manager and a step (s490) for inspecting said abnormal condition of server.

Because the monitoring information of server from SM Agent server (400) is referenced also to synchronization transmission, if abnormality is detected at a CAS server (300) that locates in path of contents synchronization, a CD Master (1000) perform contents synchronization for CAS servers (300) of the path except for the corresponding CAS server (300), and for the CAS server (300) where fault occurred after restoration the synchronization is performed by other CAS server (300) of a neighboring path.

As a result of server monitoring from SM Agent server (400), if the physical problem and software problem of a server (for example, PING failure, monitoring failure of each Port, Agent response failure etc.) and loading of CPU, Memory and Session are detected, CD Master server (100) reports the abnormality of the server to manager through an alarm, SMS and E-Mail by using of CD Master Admin Tool (500). Like this, because the manager can detect the condition of a server precisely, it is possible to coping with faults quickly.

11. Group

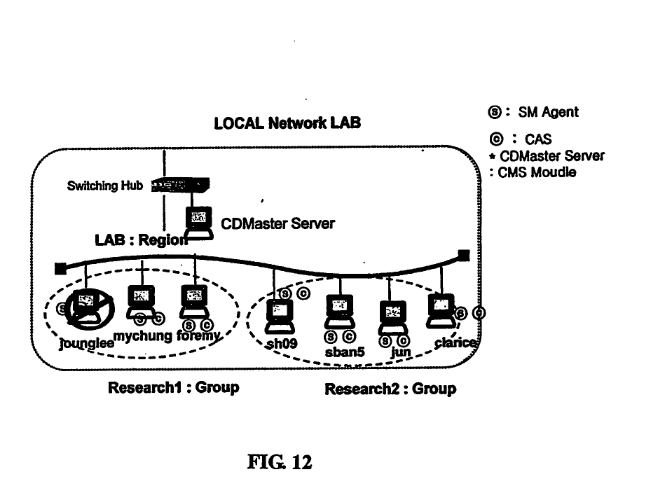

FIG. 12 illustrates a general LAN's constitution. In the operation of CD Master, the concept of group was introduced for effective contents synchronization among grouped servers on the basis of topology of network being serviced actually. Group has tree structure that consists of the Region of the top grade, the Group of the middle grade and the Server of the lowest grade.

This concept has been introduced for performing the optimal contents synchronization manually through the designated contents routing path or automatically among grouped servers based on network topology.

It is preferable to classify the servers by Region, especially to classify the physically or logically neighboring servers into a Group or Region.

Owing to Grouping of servers, when it executes contents synchronization through automatic or manual routing path, it is possible to perform effectively synchronization among the same Group or the same Region.

For a concrete example, groups named of Lab region, Research1 Research2 are created and Server1, Server2 are constituted in the group of Research1, and Server3, Server4 are constituted in the group of Research2, and when contents synchronization is performed, one source contents server executes contents synchronization with the four servers based on the grouped policy.

The grouping effect is maximized if designating the optimal routing path synchronizes contents, although manual routing path is not provided, when several servers are tied to a Group.

A local network LAB basing on the general LAN environment of FIG. 12 shown as a detailed example of the above grouping concept between servers, and consisting of a region LAB, a CD Master server (100), on the CD Master server (100) is installed CMA server (200), CAS server (300) and SM Agent server (400), the LAB region consists of two groups research1 and research2, and the research1 consists of the servers named jonglee, mychung and foremy, and the research2 consists of the servers named sh09, sban5, jun and clarice.

And each server of the below of research1 and research2 has SM Agent server (400) for server monitoring and CAS server (300) for execution of contents synchronization.

In the grouping of servers, jonglee, mychung and foremy belong to the same group, the below servers of research1 and research2 belong to the same region, and the other groups belong to the international group.

For the process of contents synchronization in the LAB, CD Master server executes contents synchronization about creation, change and deletion of data detected in real time by CMS server through each manual routing path.

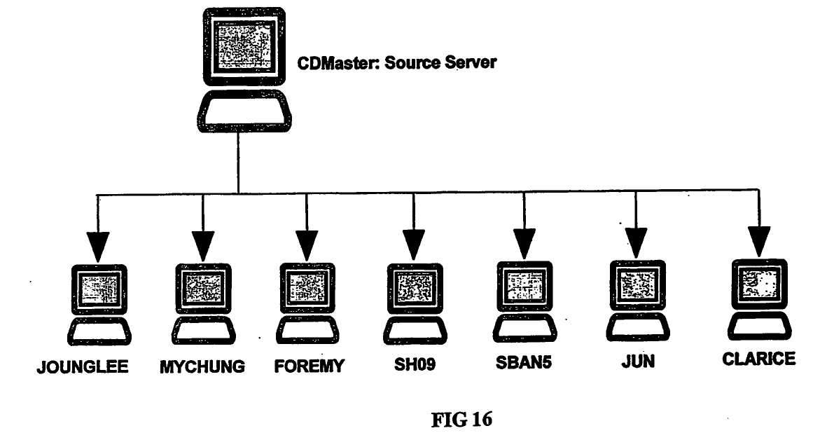

In the prior contents synchronization according to FIG. 16, if CD Master server (100) has the original data and executes contents synchronization about creation, change and deletion of data in the CD Master servers (100) to the several servers having the same functions jonglee, mychung, foremy, sh09, sban5, jun and clarice, it will cause an over load of the source server.

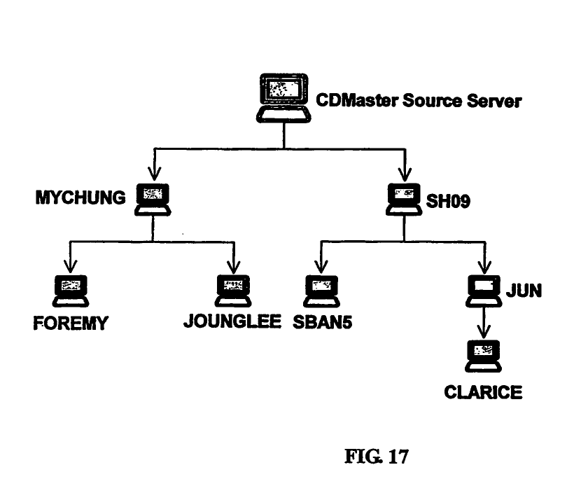

But, according to the embodiment of contents synchronization of CD Master (100) of FIG. 17, the source server offers the effective distribution function of contents through a systematic contents routing path. If the physical or software defects (for example, the case of that CPU, Memory and Session exceed critical value) occurs at a server named jonglee, the rest servers, except jonglee, execute synchronization through other servers. And after restoration of jonglee server, it executes synchronization by mychung or foremy server that is close to jonglee server and exists in the same group. Namely, in this method, the load of source server decreases, and the contents distribution is executed rapidly.

FIG. 13 shows tree structure about CAS server (300) grouping. The contents synchronization is executed after grouping as the same Group or the same Region in contemplation of network circumstances between Region, Group and Server. FIG. 13 shows a tree structure changed from the physical network structure of FIG. 12 in order to improve readability.

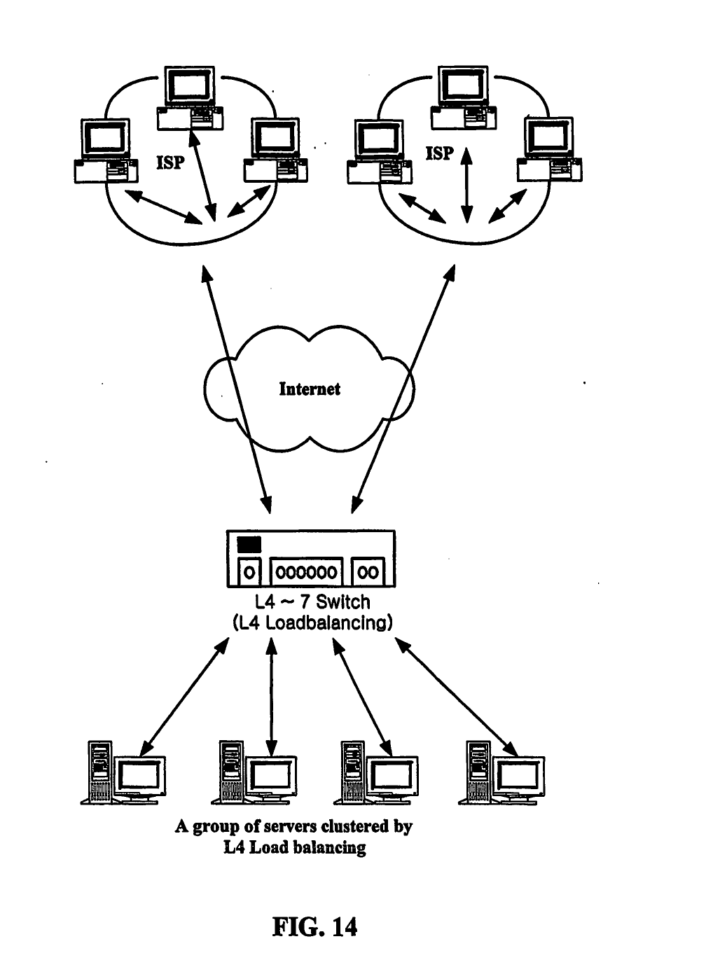

FIG. 14 illustrates the plural server groups clustered through a load balancer constructed by L4˜L7 switching equipments. Said plural server groups have the same object, and synchronize the same contents so that offer efficiently the same service to customer.

In order to perform copy, create and delete of contents between several contents servers in real time, CD Master (1000) solution is useful according to the present invention

FIG. 15 illustrates a flow chart of a procedure to issue License Key to operate a CD Master server (100). The procedure comprises the steps of \textcircled{1} setting License Information through registration at Company/Site by manager; \textcircled{2} issuing Company/Site License File to customer by manager; \textcircled{3} issuing Install License File about License Key issued to customer; \textcircled{4} setting License Information through registration at Company/Site by manager; \textcircled{5} storing received Company/Site License File from manager and issued Install License File in CD Master server (100).

After verifying customer information and certificate information by License key issued through the above process, it operates the process of CAS server (300), CMS server (200) and CD Master server (100) that are components of CD Master (1000).

The customer using a non-certificated License key has limit to normal operation of the process and cannot execute contents synchronization process.

The present invention may be modified and embodied in various forms, and it has been described and illustrated herein with reference to a specific embodiment thereof. However, it should be understood that this invention is not limited to the particular form as described above, and that this invention includes all modifications, equivalents and substitutes within the spirits and scope of this invention as defined in the “claims” attached here to.

The following effects are expected from the above embodiment of the present invention.

First, it is expected that load of server, operation time and usable quantity of network bandwidth decrease over 60% by using of intellectual data transmitting function. For a concrete example, by using of intellectual data transmission function of CD Master (1000), in case of change of the existing data, CD Master (1000) transmits only the changed part of data file, instead of transmitting the whole data file, to target server. After comparing checksum of source data file with checksum of target data file, CD Master (1000) transmits only changed part of file in order to realize the above function.

Second, owing to the monitoring creation, update, delete of contents in real time in the kernel level, it can reduce load of the server and improve the efficiency of service server.

Third, as a result of server monitoring by the SM Agent server (400), if the physical problem and software problem of server (for example, PING failure, monitoring failure of each Port, Agent response failure etc.) and loading of CPU, Memory and Session are detected, said CD master server (100) reports abnormality of server to a manager through an alarm, SMS and E-Mail by using CD Master Admin Tool (500). Like this, because the manager can detect condition of server precisely, it is possible to cope with abnormalities quickly and to improve operation efficiency.

Last, grouping is made into the same Group, the same Region, or International Group in contemplation of network circumstance between Region, Group and Server and after restoration of abnormality, any server close to the abnormal server and in the same group or region executes synchronization automatically or manually. Then it can execute synchronization efficiently too although abnormality occurs.

What is claimed is:

1. In network environment including LAN and WAN a Content Distribution Master (CD Master) that is a contents synchronization system transmitting the modified contents of source data servers to target servers, said CD Master comprising a Content Distribution Master server (CD Master server), a Content Monitoring System server (CMS server), a Content Agent System server (CAS server), a Server Monitoring Agent server (SM Agent server), a Content Distribution Master Admin Tool (CD Master Admin Tool) and an authentic server, wherein
said CD Master server manages data distribution and data transmission and controls the service circumstances of said CMS server, CAS server, SM Agent server and monitors the data transmission status and the status of said CMS server, CAS server, SM Agent server, CD Master Admin Tool, authentic server;
said CMS server monitors in real time at the operating system level whether the data of folders designated by a network manager are created, modified or deleted, and notifies the modified contents to said CD Master server;
said CAS server transmits data to other CAS servers or receives data from other CAS servers according to the instruction of said CD Master server;
said SM Agent server collects server status information about CPU, Memory, Session number of the installed CD Master server, CMS server, CAS server, CD Master Admin Tool, authentic server every constant time interval periodically and notifies the collected information to said CD Master server;
said CD Master Admin Tool of GUI (Graphic User Interface) environment being independent from operating system platform based on the development in Java environment and is a management tool to support that said CD Master system manager sets CD Master service environment easily and provides intuitive interface and sets and confirms the service environments including service server management, environment setting between said CMS server and CAS server, manager's account management, server status monitoring, scheduling, synchronization, server monitor agent setting, job log confirmation, operating environment setting through CD Master server; and
said authentic server is a license system of said contents synchronization system and issues and manages CD Master License Keys and classifies servers as tree-structured three levels of Region, Group, Server for effective contents synchronization among servers grouped based on network topology being served actually, wherein Region is the highest level, Group is a medium level, and Server is a lowest level, and manages Region, Group, CAS server, CMS server and the restriction of the usable days for operating said synchronization system.

2. A contents synchronization system as set forth in claim 1, wherein it is characterized in that said CD Master performing:
a data filtering function that includes or excludes data and uses regular expression method, wherein the include helps said CD Master to make a manager specify the kind of data to transmit to target servers and only transmit a specific kind of data to target servers, and the exclude helps CD Master to make a manager exclude a specific kind of data files from the transmission;
a multi contents generating function;
a multiple data transmission method function including real time transmission, manual transmission, reserved transmission;
a multi data transmission path setting function; and
a data transmission fail-over function by network failure.

3. A contents synchronization system as set forth in claims 1 or 2, wherein it is characterized in that said CD Master comprising:
a communication control unit controlling service environment of said CAS server, CMS server in order to centrally manage the real time distribution, manual distribution, reserved distribution of modified contents in networks and monitoring the status of said CD Master server in the path of contents transmission path and specifying the bypass in case of failure and controlling communication flow through the communication protocols with said CMS server, CAS servers, SM Agent servers, CD Master Admin Tool and authentication server;
a contents transmission management unit controlling the distribution and management of information related to the real time distribution, manual distribution, reserved distribution of contents;
a server fail over management unit controlling the specification of the bypass for contents synchronization among said CD Master server, CMS server, CAS server in case of failure of said CD Master server, CMS server, CAS server in routing path;
a real time server status monitoring management unit monitoring the status of CPU, memory, socket of source servers including said CMS server, CAS server and outputting the status of the source servers in the form of graph or table through the CD Master Admin user interface, and informing to a manager the status at once if the status of CPU, memory, socket of the monitored servers is abnormal or the status value is above a predetermined critical value; and
a contents transmission job logging and statistical information management unit performing the real time synchronization, reserved synchronization or manual synchronization about the modified contents of said CMS server and recording and controlling the logging and statistical information about the synchronization results.

4. A contents synchronization system as set forth in claim 2, wherein it is characterized in that said multi contents generating function makes it possible for said CD Master to designate the synchronization timing of data diversely and to perform synchronization and backup of data by transmitting data in multiple source servers to all target servers and for every changed data of a specific data center to be transmitted to all target servers of another network center or another region, wherein in case N and M are arbitrary natural numbers, the transmission service is called as N:M type data transmission service.

5. A contents synchronization system as set forth in claim 2, wherein it is characterized in that said diverse data transmission function makes that in case data of source servers is changed, data synchronization timing of target servers is set as one of a real time transmission to transmit data at once to all target servers, a manual transmission for a manager to instruct transmission of data manually, and a reserved transmission to transmit data at a designated specific time or every regular time interval.

6. A contents synchronization system as set forth in claim 2, wherein it is characterized in that said diverse data transmission path setting function makes it possible for said CD Master to have a manager set data transmission path flexibly according to network structure and status of said CAS server, CMS server and SM Agent server by making said CD Master use a grid network method and in case of data transmission each service server shortens the contents replication time by allotting a role and reduces the burden of CPU and network of each service server up to the least and distributes load according to the hardware specification of each service server.

7. A contents synchronization system as set forth in claim 2, wherein it is characterized in that in case of network's failure, the data transmission fail-over function makes it possible for said CD Master to transmit data via bypass by preparing for a case of no-transmission of data in a specific section and by monitoring the no-transmission, wherein it is checked whether the provided bypass belongs to the same Group, to the same Region or to an international Region among Region, Group and Server of an existing structured network and data is transmitted again from a nearest CAS server and in case data cannot be transmitted from every CAS server because of a fatal problem of a server, and the transmission is retried a predetermined times and if the result of transmission of the CAS server is fail, said CD Master server performs contents synchronization for corresponding target servers according to the recovery procedure of preset target servers in case of failure recovery of target servers in which the corresponding failure occurred and in the procedure it should be set selectively according to the circumstances whether contents synchronization should be performed at once after server's failure is recovered, or contents synchronization should be performed at a reserved time which a manager designated, or contents synchronization of target servers having failure transmission should be performed manually

8. A contents synchronization system as set forth in claim 1, wherein it is characterized in that said CAS server comprises:
a Sync Client, a library performing functions of create, update, rename, delete, erase, move of files according to the command of said CAS server,
a Sync Server, transmitting data to other CAS servers by performing one of create, update, rename, delete, erase and move of files or folders for monitoring directories detected by said CMS server according to the instructions of said CD Master or receiving data from other CAS servers and storing remote files to local through communication according to the request of said remote Sync Client, which is an independent process from said CAS server internally;
a routing table for the contents synchronization; and
a CAS agent performing commands transmitted from said CD Master.

9. A contents synchronization system as set forth in claim 1, wherein it is characterized in that said CMS server comprises:
a device driver at kernel level of operating system, notified information about directories and files to be monitored for creation, deletion, modification, movement of files and environment files about patterns of files to be monitored from said CD Master server and notifying information about create, delete, modify, move of files and directories by in real time monitoring the change of the files and directories to said CD Master server in case files change in corresponding environment;
a CMS Agent for contents synchronization for defining original files and directories for that contents synchronization will be performed, synchronization patterns;
an environment setting file; and
a File Detect Buffer for storing created, deleted, modified, moved information by monitoring the modified contents in real time.

10. A contents synchronization system as set forth in claim 1, wherein it is characterized in that said SM Agent server notifies to a manager whether servers are normal or abnormal by using E-mail, SMS, Alarm functions when servers have physical failure or information about CPU, Memory, Session is above critical value by updating server information about CPU, Memory, Session number of servers in constant cycle

11. A contents synchronization system as set forth in claim 10, wherein it is characterized in that said server monitoring information is got by said SM Agent server and referenced in transmission for synchronization of said CD Master and if failure of a CAS server of contents synchronization path is monitored, said CD Master performs contents synchronization for other CAS servers except the corresponding CAS server and in case the corresponding CAS server, in which the failure has occurred is recovered later, then the synchronization is performed by a CAS server in neighboring other path and in case as a result of monitoring by said SM Agent server, server's physical problems or software problems including PING failure, failure of each PORT monitoring, Agent response failure, or load of CPU, Memory and Session are monitored, said CD Master server notifies the monitored results to a manager through alarm information, SMS, E-mail by using CD Master Admin Tool and makes the manager check the status of servers and respond rapidly for failures.

12. A contents synchronization system as set forth in claim 1, wherein it is characterized in that
a management function of said service servers makes it possible through said CD Master Admin Tool that a network manager adds a server newly to be a service object of said CD Master and modifies and deletes the environments of existing registered servers;
an environment setting function of said CMS server and CAS servers makes it possible for said CMS server to set files and folders to be monitored and to set path to store data received from CAS servers installed in other servers;
a management function of said manager account creates, modifies, deletes the account and information of the manager with that the access to said CD Master Admin Tool is possible;
said server monitoring function shows the current status of registered service servers in forms of graph and table;
said work log confirmation function makes it possible to confirm all job log about all synchronization jobs, manual jobs, reserved jobs that are performed under control of said CD Master server; and
said management function is an application of GUI environment that can operate independently from platforms of operating system, and makes it possible to manage network easily and simply.

13. A contents synchronization system as set forth in claim 12, wherein it is characterized in that said CD Master Admin tool sets environments related to communication environment of said CAS servers, original directories and mapping directories through environment setting function of said CAS servers.

14. A contents synchronization system as set forth in claim 1, wherein it is characterized in that said Group from the point of view of CD Master operation can perform optimal contents synchronization automatically or manually through designated contents routing path among grouped servers based on network topology, and classification by Region and Grouping among servers classify logically neighboring servers into a Group or a Region and the Grouping among servers makes it possible to perform synchronization effectively in same Groups or same Regions in case of contents synchronization according to the automatic or manual routing path and when several servers are combined by groups, although manual routing path is not provided, the effects of contents synchronization is maximized by designating optimal routing path.

15. A contents synchronization system as set forth in claim 1, wherein it is characterized in that said system keeps contents of all server groups identical with each other in order to provide services according to the objects for multiple server groups clustered through load balancer installed with switching facilities, wherein said server groups have the same objects.

16. In network environment including LAN and WAN a contents synchronization method using a contents synchronization system transmitting the modified contents of source servers to target servers, said system having a Content Distribution Master server (CD Master server), a Content Monitoring System server (CMS server), several Content Agent System servers (CAS servers), a Server Monitoring Agent server (SM Agent server), a Content Distribution Master Admin Tool (CD Master Admin Tool) and an authentic server, said method comprising:
a step for setting the synchronization policy by the CD Master Admin Tool;
a step for monitoring files and directories of a specific server in real time according to the set policy by the CMS server;
a step for checking by the CMS server whether there are creation, modification, deletion or move of contents as a result of the monitoring;
a step for performing said monitoring step again if there are no creation, modification, deletion or move of contents as a result of said check, but if there are creation, modification, deletion or move of contents, then notifying of the CMS server to the CD Master server in real time that there are creation, modification, deletion or move of contents;
a step for confirming by the CD Master server whether there is failure among the CD Master server, the CMS server, the CAS servers according to the contents routing path;
a step for selecting a predefined contents routing path if there are creation, modification, deletion or move of contents as a result of said confirmation;
a step for selecting a contents routing path by selecting a bypass if there are no creation, modification, deletion or move of contents as a result of said confirmation;
a step for instructing by the CD Master server a synchronization command to each CAS server to transmit said created, modified, deleted or moved contents to target servers;
a step for transmitting the corresponding contents to target servers according to designated path or bypass by the CAS server;
a step for notifying the transmission results to the CD Master server by the CAS server after said transmittance;
a step for confirming by the CD Master server whether there is a next contents routing path; and
a step for performing said step for confirming by the CD Master server whether there is failure among the CD Master server, the CMS server, the CAS servers again if there is next contents routing path but completing the contents synchronization if there is no next contents routing path as a result of said confirmation.

17. A contents synchronization method as set forth in claim 16, wherein it is characterized in that said method comprises further a step for issuing said license key by the authentication server, and said issuing step has steps for:
setting license information through registration at Company/Site by a manager;
issuing Company/Site License Files to customers by the manager;
issuing Install License File about License Key issued to customer;
setting license information through registration at Company/Site by the manager; and
storing the Company/Site License Files received from the manager and the issued Install License Files in the CD Master server.

18. A contents synchronization method as set forth in claim 17, wherein it is characterized in that the verification about customer information and certificate information is performed by License key issued through the above process and operates the process of the CAS servers, CMS server and CD Master server and customers using a non-certificated license key has limit to operation of the normal process and cannot execute contents synchronization process.

19. A contents synchronization method as set forth in any one of claims 16 to 18, wherein it is characterized in that the operation of the CAS servers comprises:
a step for receiving jobs for synchronization by the CAS servers from the CD master server;
a step for confirming IP addresses of another CAS server or other CAS servers that would execute synchronization by searching the routing tables stored in the CAS servers by CAS Agents that received synchronization commands from the CD Master server;
a step for calling Sync Clients locating in CAS servers;
a step for executing create, update, rename, delete or move commands for synchronization in the CAS servers by the Sync Clients;
a step for transmitting the performance results of said transmitted jobs to the Sync Servers locating at a long distance;
a step for notifying the performance results of said transmitted jobs to CAS agent by local Sync Clients; and
a step for completing contents synchronization among all CAS servers by contents routing path and receiving the completed results of the synchronization jobs from each CAS server and transmitting the results to the CD Master server.

20. A contents synchronization method as set forth in any one of claims 16 to 18, wherein it is characterized in that
in case of data transmission among the CAS servers compressed data transmission function is performed and in case of contents synchronization the compressed data transmission function compresses and encodes data and reduces network's load,
said file transmission is specified in consideration of characteristics of network structure including International Region that does not belong to Same Region, Same Group,
in case of the file transmission the whole files are dump copied but in case of frequently updated files only the changed parts of files are transmitted after comparison of files, wherein the transmission method is called as different patch,
contents synchronization is performed by defining whether encryption is used or not by combination of AND conditions, or at the same time by specifying whether SSL encryption is used and whether dump copy or different patch is used,
the manager sets predetermined multi-level compression rates in consideration of network bandwidth of each transmission section,
the CD Master server supports packet encryption of transmission data using SSL and previously intercepts information leakage through hacking by using encryption function in order to protect important data and contents of enterprises and persons, and
it is possible to define SSL encryption section selectively among the whole sections of source servers and target servers, wherein by reflecting network status of LAN and WAN sections to the maximum and setting, transmission rate increases and data is protected safely.

21. A contents synchronization method as set forth in any one of claims 16 to 18, wherein it is characterized in that a transmission algorithm for contents synchronization of the CAS servers comprises:
a step for transmitting Offsets of source files and list of 32-bit rolling checksum from a CAS server (hereafter called as CAS server A) to another CAS server (hereafter called as CAS server B) among several CAS servers, in case there exist similar files between CAS server A and CAS server B;
a step by CAS server B for comparing checksum of the corresponding index of said transmitted files by using hashing technique;
a step for only transmitting the corresponding indexes and changed parts to CAS server A by CAS server B if discordant parts are detected from results of said comparison, and
a step for only updating the discordant parts from CAS server A to CAS server B.

22. A contents synchronization method as set forth in any one of claims 16 to 18, wherein it is characterized in that operation procedure of the SM Agent server comprises:
a step for collecting information about CPU, Memory and Session that are system resources of source servers;
a step for transmitting said collected information to the CD Master server;
a step for receiving said collected information by the CD Master server;
a step for constructing database from said received data;
a step for confirming whether servers are normal or not based on said collected information;
a step for reporting said confirmation results of servers to a manager through a predetermined method including an alarm, SMS and E-Mail;
a step for recognizing failure through the CD Master Admin Tool by the manager; and
a step for inspecting status of servers.
